(19) United States
(12) Patent Application Publication
(10) Pub. No.: US 2015/0112655 A1
(43) Pub. Date: Apr. 23, 2015

(54) COMPUTING DEVICE AND METHOD FOR SIMULATING MEASUREMENT OF OBJECT

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventors: CHIH-KUANG CHANG, New Taipei (TW); XIN-YUAN WU, Shenzhen (CN)

(21) Appl. No.: 14/512,593

(22) Filed: Oct. 13, 2014

(30) Foreign Application Priority Data
Oct. 18, 2013 (CN) 201310493081.9

(51) Int. Cl. G06F 17/50

(52) U.S. Cl. CPC G06F 17/5009
USPC 703/6

(57) ABSTRACT

In a method for simulating measurements of an object using a computing device, a virtual probe and a user interface including icons for controlling the virtual probe are created. Point cloud data of the object is acquired and meshed into triangles for outputting a meshed model. The virtual probe, the user interface, and the meshed model are imported to be displayed on a display screen. A head of the virtual probe is controlled to move onto the meshed model for selecting a measurement point from the meshed model. Initial coordinates of the measurement point on the meshed model is calculated. The virtual probe is controlled to move onto an arbitrary point, and a measurement path between the measurement point and the arbitrary point is established. The virtual probe is controlled to simulate a movement along the measurement path.

### CROSS-REFERENCE TO RELATED APPLICATIONS

This application claims priority to Chinese Patent Application No. 201310493081.9 filed on Oct. 18, 2013, the contents of which are incorporated by reference herein.

### FIELD

Embodiments of the present disclosure relate to measurement technology, and particularly to a computing device and a method for simulating measurements of an object using the computing device.

### BACKGROUND

For a three-dimensional (3D) measurement machine to execute an automatic measurement for an object (for example, a workpiece), a measurement program (including measurement path) first needs to be prepared. Generally, a mouse can be used on a computer-aided design (CAD) drawing of the object to program measurements. However, there can still be differences between the CAD drawing and the actual object. Therefore, the measurements of the object using the measurement programs based on the CAD drawing of the object are not perfectly accurate, and collisions between a probe and the actual object cannot be completely avoided because of the inaccurate data in the measurement programs.

### BRIEF DESCRIPTION OF THE DRAWINGS

Implementations of the present disclosure will be described, by way of example only, with reference to the following drawings. The modules in the drawings are not necessarily drawn to scale, the emphasis instead being placed upon clearly illustrating the principles of the present disclosure. Moreover, in the drawings, like reference numerals designate corresponding portions throughout the views.

FIG. 1 is a block diagram of one embodiment of a computing device including a measurement simulation system.

FIG. 2 is a flowchart of one embodiment of a method for simulating measurements of an object using the computing device in FIG. 1.

FIG. 3A and FIG. 3B are diagrammatic views of embodiments of a virtual probe and a user interface including a plurality of icons.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references can mean “at least one,” or “one or more.” It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

In the present disclosure, “module,” refers to logic embodied in hardware or firmware, or to a collection of software instructions, written in a program language. In at least one embodiment, the program language can be Java, C, or assembly. One or more software instructions in the modules can be embedded in firmware, such as in an erasable programmable read only memory (EPROM). The modules described herein can be implemented as either software and/or hardware modules and can be stored in any type of non-transitory computer-readable media or storage medium. Non-limiting examples of a non-transitory computer-readable medium include CDs, DVDs, flash memory, and hard disk drives. The term “comprising” means “including, but not necessarily limited to”; it specifically indicates open-ended inclusion or membership in a so-described combination, group, series and the like.

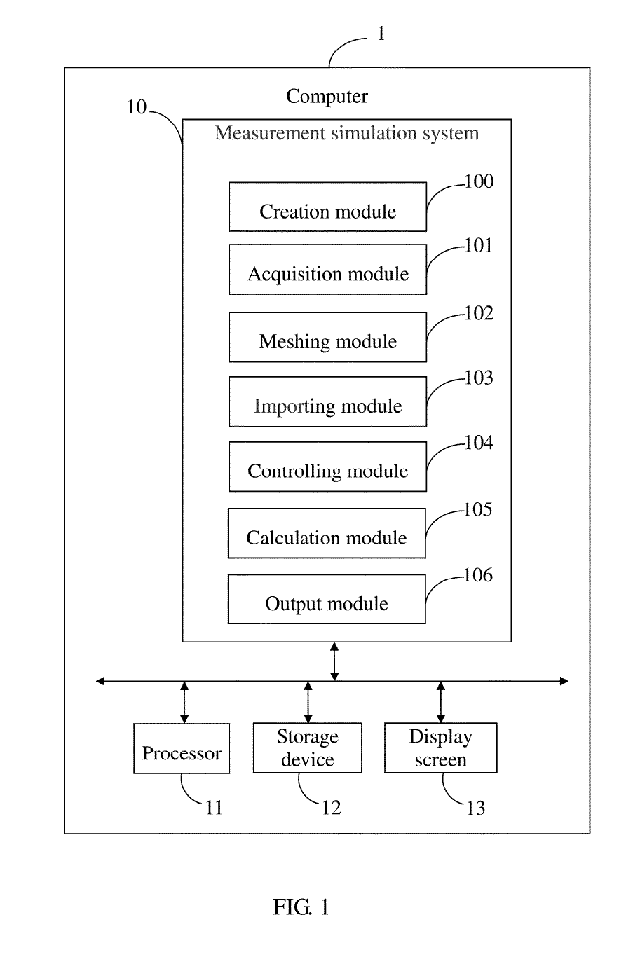

FIG. 1 is a block diagram of one embodiment of a computing device including a measurement simulation system. The computing device 1 includes, but is not limited to, a measurement simulation system 10, at least one processor 11, a storage device 12, and a display screen 13. The at least one processor 11 executes one or more computerized codes and other applications of the computing device 1 to provide functions of the measurement simulation system 10. The storage device 12 can be an internal storage device, such as a random access memory (RAM) for temporary storage of information, and/or a read only memory (ROM) for permanent storage of information. The storage device 12 can also be an external storage device, such as an external hard disk, a storage card, or a data storage medium. In at least one embodiment, the storage device 12 can store three-dimensional point cloud data of an object (for example, a workpiece).

In this embodiment, the measurement simulation system 10 includes, but is not limited to, a creation module 100, an acquisition module 101, a meshing module 102, an importing module 103, a controlling module 104, a calculation module 105, and an outputting module 106. The modules 100-106 include computerized code in the form of one or more programs that are stored in the storage device 12. The computerized code includes instructions that are executed by the at least one processor 11 to provide functions of the measurement simulation system 10.

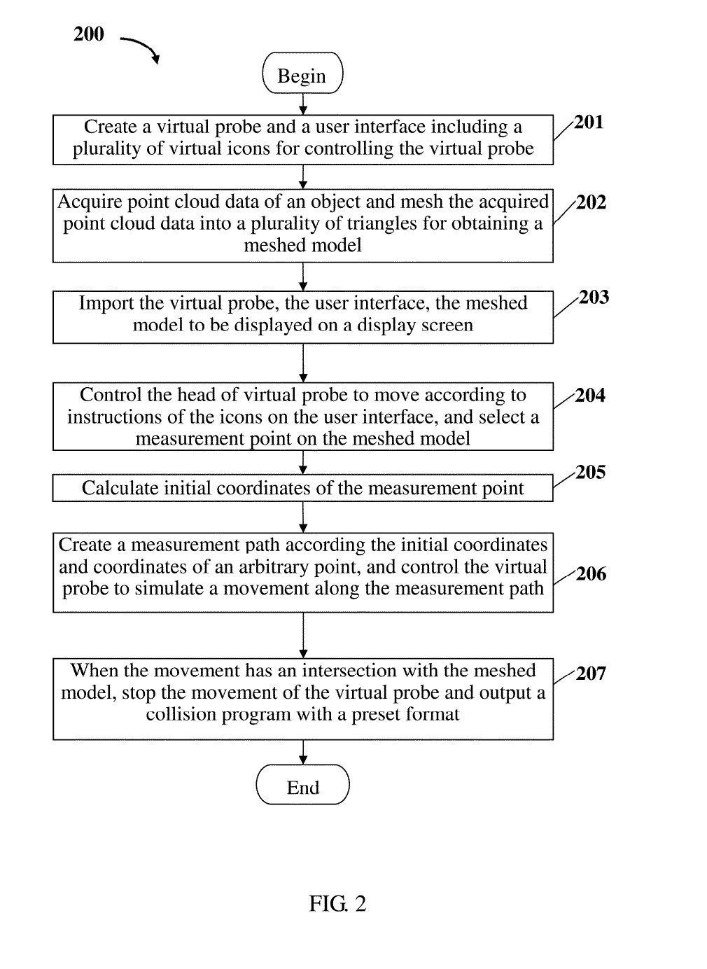

FIG. 2 illustrates a flowchart of one embodiment of a method for simulating measurements of an object using the computing device in FIG. 1. In the example embodiment, the method is performed by execution of computer-readable software program codes or instructions by at least one processor of the computing device 1. The method can simulate measurement of points in the point cloud of an object, and control a virtual probe to simulate movements along a measurement for outputting a collision program.

Referring to FIG. 2, a flowchart is presented in accordance with an example embodiment which is being thus illustrated. In the embodiment, the example method 200 is provided by way of example only as there are a variety of ways to carry out the method. The method 200 described below can be carried out using the configurations illustrated in FIG. 1, for example, and various elements of these figures are referenced in explaining the example method 200. Each block shown in FIG. 2 represents one or more processes, methods or subroutines, carried out in the exemplary method 200. Additionally, the illustrated order of blocks is by example only and the order of the blocks can be changed according to the present disclosure. The exemplary method 200 can begin at block 201.

At block 201, the creation module creates a virtual probe and a user interface including a plurality of icons for controlling the virtual probe. In at least one embodiment, the virtual probe can be a three-dimensional (3D) model of an actual probe in accordance with a shape and a size of the actual probe. The icons on the user interface are associated with movements of the probe mode. When a user operates (for example, clicking) on one of the icons, a corresponding instruction can be triggered for controlling the virtual probe to move along a corresponding direction.

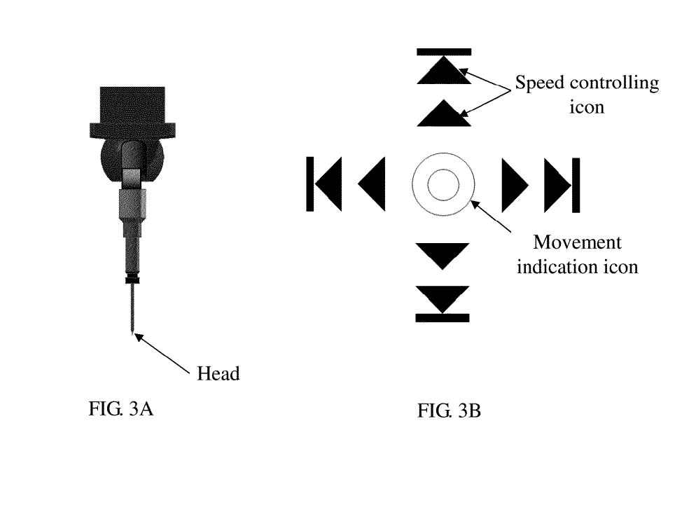

FIG. 3A and FIG. 3B are diagrammatic views of one embodiment of a virtual probe and a user interface including a plurality of icons. As shown in FIG. 3A, the virtual probe includes a head for measuring points of the object. The virtual icons include, but are not limited to, a plurality groups of speed controlling icons with different directions and at least one movement indication icon. The speed controlling icons can trigger different movement instructions.

As shown in FIG. 3B, there are four groups of speed controlling icons with four direction (for example, up, down, left and right), and each groups of speed controlling icons includes a fast speed controlling icon and a slow speed controlling icon. The slow speed controlling icon can be used to control the virtual probe to move with a first speed (for example, 1 mm/s). The fast speed controlling icon can be used to control the virtual probe to move with a second speed (for example 1 cm/s) which is faster than the first speed. The first speed and the second speed can be preset according to measurement requirements.

When no operation is detected or received on any speed controlling icon from the user interface, the movement indication icon can displayed with an initial state (for example, a first color or color combination). When one of the slow speed controlling icons is being triggered, the movement indication icon can be displayed with a second state (for example, a second color or color combination). When one of the fast speed controlling icons is being triggered, the movement indication icon can be displayed with a third state (for example, a third color or color combination).

At block 202, the acquisition module acquires point cloud data of an object from the storage device 12, and the meshing module meshes the acquired point cloud data into a plurality of triangles and outputs a meshed model including the plurality of triangles based on at least one preset rule. In at least one embodiment, the acquisition module can acquire three dimensional (3D) point cloud data of the object from the storage device 12, or from a scanning device which can scan and obtain the 3D point cloud data of the object.

In at least one embodiment, the at least one preset rule can include a first rule that no point in the point cloud is inside the circumscribed circles of the triangles, and a second rule that curvatures of neighboring triangles are similar to each other. When a triangle is formed based on the first rule, the triangle can be examined based on the second rule. An angle between a vector of the triangle and a vector of each neighboring triangle of the triangle can be computed. If there is an angle between the vector of the triangle and the vector of the neighboring triangle greater than a preset curvature threshold (for example, 90°), the triangle will be discarded and reconstructed with other points to generate a new triangle.

For example, the meshing module selects a point in the point cloud as a first point of a triangle, and further select a point near the first point as a second point. In at least one embodiment, a threshold of a distant between the first point and the second point can be preset by a user. In at least one embodiment, the meshing module can select the nearest point for the first point. The meshing module connects the first point and the second point, and determines a third point of the triangle that there is no point in a circumcircle of the triangle which is consisting of the first point, the second point and the third point.

In other embodiments, the plurality of triangles meshed from the acquired point cloud data can be simplified accord to a preset method. For example, the preset method is described as: deducting a preset percentage (for example, 30%) of the triangles whose curvatures are within a preset range (for example, a range from 0° to 10°).

At block 203, the importing module import the virtual probe, the user interface, and the meshed model to be displayed on the display screen 13.

At block 204, the controlling module receives movement instructions triggered by the icons on the user interface, and controls a head of the virtual probe to move onto the meshed model for selecting a measurement point from the meshed model. That is, the head of the virtual probe is on the measurement point. When the virtual probe is controlled to be moved, the movement indication icon in the user interface can be displayed with the second state or the third state. In other embodiment, the controlling module can control the virtual probe to move accordingly when the user inputs coordinates.

At block 205, the calculation module calculates initial coordinates of the measurement point on the meshed model. In at least one embodiment, the initial coordinates of the measurement point can be calculated by: generating a ray passing through the first measured point along a normal line of the display screen 13; searching for neighboring triangles in the meshed model which are adjacent to the first measured point based on a specific algorithm (for example, a bounding box algorithm), and obtaining intersections between the ray and the searched triangles; and determining an external vertex of the intersections at which the ray intersects with an external surface of the meshed model. In at least one embodiment, the meshed model can be divided into a plurality of small boxes based on the bounding box algorithm. Each of the small boxes can be assigned a specific number so that the plurality of neighboring triangles adjacent to the first measured point can be easily obtained based on the specific numbers.

In at least one embodiment, since there are many intersections between the meshed model and the ray in a forward direction and between the meshed model and the ray in a backward direction, the calculation module obtains an intersection between the ray and the meshed model based on the intersections. In addition, a ray is externally generated from a point on the surface of the meshed model, intersecting with the meshed model only at the point on the surface of the meshed model. Therefore, the calculation can obtain an external vertex of the intersection line at which the ray intersects with a surface of the meshed model. The external vertex can be regarded as the measurement point by the calculation module.

At block 206, the controlling module controls the virtual probe to move onto an arbitrary point according to the instructions of the icons, establishes a measurement path between the measurement point and the arbitrary point, and controls the virtual probe to simulate a movement along the measurement path. In at least one embodiment, the measurement path can be a beeline between the arbitrary point and the measurement point.

At block 207, the controlling module determines whether the movement along the measurement path has an intersection with the meshed model, and the outputting module stops the movement of the virtual probe and outputs a collision program with a preset format when the movement along the measurement path has the intersection with the meshed model.

In at least one embodiment, when the virtual probe moves along the measurement path, the controlling module executes an approach point simulation and a return point simulation for each point on the measurement path according to a preset approach threshold (for example, 2 mm) and a preset return simulation threshold (for example, 2 mm). Coordinates of each approach point are a sum of coordinates of each point on the measurement path and coordinates of “(0, 0, the preset approach threshold)”, and coordinates of each return point are a difference between coordinates of each point on the measurement path and coordinates of “(0, 0, the preset return threshold)”. Each approach point can form a second path and each return point can form a third path. That is, there are three paths. If at least one path intersects with the meshed model, the controlling module determines that the movement along the measurement path has the intersection with the meshed model. If no path intersects with the meshed model, the controlling module determines that the movement along the measurement path does not have the intersection with the meshed model.

In at least one embodiment, the collision program can includes coordinates of the starting point (e.g., the measurement point) and the end point (e.g., the arbitrary point) of the measurement path, coordinates and normal vector of the points on the measurement path which the movement of the virtual probe has passed through. When the movement along the measurement path does not have the intersection with the meshed model, the user can control the virtual probe to move onto another arbitrary point for measurements on a different measurement path.

All of the processes described above can be embodied in, and fully automated via, functional code modules executed by one or more general purpose processors such as the processor 11. The code modules can be stored in any type of non-transitory readable medium or other storage device such as the storage device 12. Some or all of the methods can alternatively be embodied in specialized hardware. Depending on the embodiment, the non-transitory readable medium can be a hard disk drive, a compact disc, a digital versatile disc, a tape drive, or other storage medium.

The described embodiments are merely examples of implementations, and have been set forth for a clear understanding of the principles of the present disclosure. Variations and modifications within this disclosure. All such modifications and variations are intended to be included within the scope of this disclosure and the described inventive embodiments, and the present disclosure is protected by the following claims and their equivalents.

What is claimed is:

1. A computer-implemented method for simulating measurements of an object using a computing device, the method comprising:
creating a virtual probe and a user interface comprising a plurality of icons for controlling the virtual probe;
acquiring point cloud data of the object from a storage device of the computing device;
meshing the point cloud data into a plurality of triangles and outputting a meshed model comprising the plurality of triangles;
importing the virtual probe, the user interface, and the meshed model to be displayed on a display screen of the computing device;
controlling a head of the virtual probe to move onto the meshed model for selecting a measurement point from the meshed model, according to receiving movement instructions triggered by the icons on the user interface;
calculating initial coordinates of the measurement point on the meshed model;
controlling the virtual probe to move onto an arbitrary point, and establishing a measurement path between the measurement point and the arbitrary point; and
controlling the virtual probe to simulate a movement along the measurement path.

2. The method according to claim 1, further comprising:
stopping the movement of the virtual probe and outputting a collision program with a preset format when the movement along the measurement path has the intersection with the meshed model.

3. The method according to claim 1, wherein the virtual icons comprise a plurality groups of speed controlling icons with different directions and at least one movement indication icon, and each of the plurality of groups of speed controlling icons comprise a fast speed controlling icon and a slow speed controlling icon.

4. The method according to claim 3, wherein the slow speed controlling icon controls the virtual probe to move with a first speed, and the fast speed controlling icon controls the virtual probe to move with a second speed which is faster than the first speed.

5. The method according to claim 3, wherein the movement indication icon is displayed with an initial state when no operation is detected or received on any speed controlling icon from the user interface, the movement indication icon is displayed with a second state when one of the slow speed controlling icons is being triggered, and the movement indication icon is displayed with a third state when one of the fast speed controlling icons is being triggered.

6. The method according to claim 1, wherein the initial coordinates of the measurement point is calculated by:
generating a ray passing through the first measured point along a normal line of the display screen;
searching for neighboring triangles in the meshed model which are adjacent to the first measured point based on a specific algorithm;
obtaining intersections between the ray and the searched triangles; and
determining an external vertex of the intersections at which the ray intersects with an external surface of the meshed model.

7. A non-transitory computer-readable storage medium storing a set of instructions, when executed by at least one processor of a computing device, cause the at least one processor to perform a method for simulating measurements of an object, the method comprising:
creating a virtual probe and a user interface comprising a plurality of icons for controlling the virtual probe;
acquiring point cloud data of the object from a storage device of the computing device;
meshing the acquired point cloud data into a plurality of triangles and outputting a meshed model comprising the plurality of triangles;
importing the virtual probe, the user interface, and the meshed model to be displayed on a display screen of the computing device;
controlling a head of the virtual probe to move onto the meshed model for selecting a measurement point from the meshed model, according to receiving movement instructions triggered by the icons on the user interface;
calculating initial coordinates of the measurement point on the meshed model;
controlling the virtual probe to move onto an arbitrary point, and establishing a measurement path between the measurement point and the arbitrary point; and
controlling the virtual probe to simulate a movement along the measurement path.

8. The storage medium according to claim 7, wherein the method further comprises:
stopping the movement of the virtual probe and outputting a collision program with a preset format when the movement along the measurement path has the intersection with the meshed model.

9. The storage medium according to claim 7, wherein the virtual icons comprise a plurality groups of speed controlling icons with different directions and at least one movement indication icon, and each of the plurality of groups of speed controlling icons comprise a fast speed controlling icon and a slow speed controlling icon.

10. The storage medium according to claim 9, wherein the slow speed controlling icon controls the virtual probe to move with a first speed, and the fast speed controlling icon controls the virtual probe to move with a second speed which is faster than the first speed.

11. The storage medium according to claim 9, wherein the movement indication icon is displayed with an initial state when no operation is detected or received on any speed controlling icon from the user interface, the movement indication icon is displayed with a second state when one of the slow speed controlling icons is being triggered, and the movement indication icon is displayed with a third state when one of the fast speed controlling icons is being triggered.

12. The storage medium according to claim 7, wherein the initial coordinates of the measurement point is calculated by:
generating a ray passing through the first measured point along a normal line of the display screen;
searching for neighboring triangles in the meshed model which are adjacent to the first measured point based on a specific algorithm;
obtaining intersections between the ray and the searched triangles; and
determining an external vertex of the intersections at which the ray intersects with an external surface of the meshed model.

13. A computing device, comprising:
a display screen;
at least one processor; and
a storage device storing one or more programs, which when executed by the at least one processor, cause the at least one processor to:
create a virtual probe and a user interface comprising a plurality of icons for controlling the virtual probe;
acquire point cloud data of the object from the storage device;
mesh the acquired point cloud data into a plurality of triangles and output a meshed model comprising the plurality of triangles;
import the virtual probe, the user interface, and the meshed model to be displayed on the display screen;
control a head of the virtual probe to move onto the meshed model for selecting a measurement point from the meshed model, according to receiving movement instructions triggered by the icons on the user interface;
calculate initial coordinates of the measurement point on the meshed model;
control the virtual probe to move onto an arbitrary point, and establish a measurement path between the measurement point and the arbitrary point; and
control the virtual probe to simulate a movement along the measurement path.

14. The computing device according to claim 13, wherein the one or more programs further stops the movement of the virtual probe and outputting a collision program with a preset format when the movement along the measurement path has the intersection with the meshed model.

15. The computing device according to claim 13, wherein the virtual icons comprise a plurality groups of speed controlling icons with different directions and at least one movement indication icon, and each of the plurality of groups of speed controlling icons comprise a fast speed controlling icon and a slow speed controlling icon.

16. The computing device according to claim 15, wherein the slow speed controlling icon controls the virtual probe to move with a first speed, and the fast speed controlling icon controls the virtual probe to move with a second speed which is faster than the first speed.

17. The computing device according to claim 15, wherein the movement indication icon is displayed with an initial state when no operation is detected or received on any speed controlling icon from the user interface, the movement indication icon is displayed with a second state when one of the slow speed controlling icons is being triggered, and the movement indication icon is displayed with a third state when one of the fast speed controlling icons is being triggered.

18. The computing device according to claim 13, wherein the initial coordinates of the measurement point is calculated by:
generating a ray passing through the first measured point along a normal line of the display screen;
searching for neighboring triangles in the meshed model which are adjacent to the first measured point based on a specific algorithm;
obtaining intersections between the ray and the searched triangles; and
determining an external vertex of the intersections at which the ray intersects with an external surface of the meshed model.
